(19) United States
(12) Patent Application Publication
(10) Pub. No.: US 2016/0006812 A1
(43) Pub. Date: Jan. 7, 2016

(54) Robust Communication Protocol, Pairing Procedure and Emergency Messaging System For a Server Computer And at Least Two Client Computers

(71) Applicant: Bernard Anthony Xavier, Del Mar, CA (US)

(72) Inventor: Bernard Anthony Xavier, Del Mar, CA (US)

(21) Appl. No.: 14/322,088

(22) Filed: Jul. 2, 2014

(51) Int. Cl. H04L 29/08; H04W 4/00

(52) U.S. Cl. CPC H04L 67/12; H04W 4/008; H04W 4/22

(57) ABSTRACT

A computer system consisting of a server or host computer and at least two client computers that provide input and output services for the server or host computer, the system of server/client computers are connected in a configuration and that follow a protocol that increases the likelihood of successful transmission of pairing or emergency messages.

### RELATED APPLICATIONS

This application claims the priority of U.S. provisional applications Nos. 61/842462, 61/842502, 61/842506, and 61/842509, all filed on Jul. 3, 2013. Each of these applications is herein incorporated by reference in their entirety for all purposes.

### BACKGROUND OF THE INVENTION

1. Field of the Invention

The present invention is in the field of telecommunications; more particularly the present invention is in the area of communication and control between host and client computers, pairing algorithms and emergency messaging.

2. Description of Related Art

Existing communications devices employ a single radio transmission device to relay a message to a base or master control center. In the event the radio channel is compromised the message may not be sent, and pairing of host and client devices may not be achieved.

Senior citizens typically have a pendant with a call button on it that relays an emergency message to a central control unit. They use this system if they are in distress. This system relies on a successful transmission of the emergency message over a communications channel. Failure of the channel results in unsuccessful emergency message transmission

### SUMMARY OF THE INVENTION

The system comprises consists of an input device, an output device and a server. The input device and the output device must establish a unique pairing to ensure that the users input controls the correct output device.

In accordance with the present invention a system comprising multiple communications protocols and channels to increase the probability of a successful message transmission is presented. The proposed system comprises at least two computer units that act as the input and output devices in a server hosted system. These devices pass information to a remote server via a wireless local area network connected to a wide area network and communicate between each other using a second but different wireless local area network. Information sent over the primary wireless data communication network by one device, e.g, a tablet computer or smartphone, is retransmitted to the second device, e.g., an internet connected TV, etc, via the second wireless data network. The second device then retransmits the information over the primary wireless communications network. This maximizes the successful transmission probability of a message.

The primary and secondary wireless local area networks may connect to wide area networks via cellular telephone, paging or land line networks. In this way the system may use the cellular phone network, the wireless paging network, the land line network, wide area data networks or any combination of them to ensure the transmitted signal is received.

### BRIEF DESCRIPTION OF THE DRAWINGS

FIG. 1 shows a setup connecting a server of host computer to at least two different client computers.

FIG. 2 shows the data flow between the server and user input and output devices.

FIG. 3 shows the method of pairing up the user input and output devices.

### DETAILED DESCRIPTION OF THE INVENTION

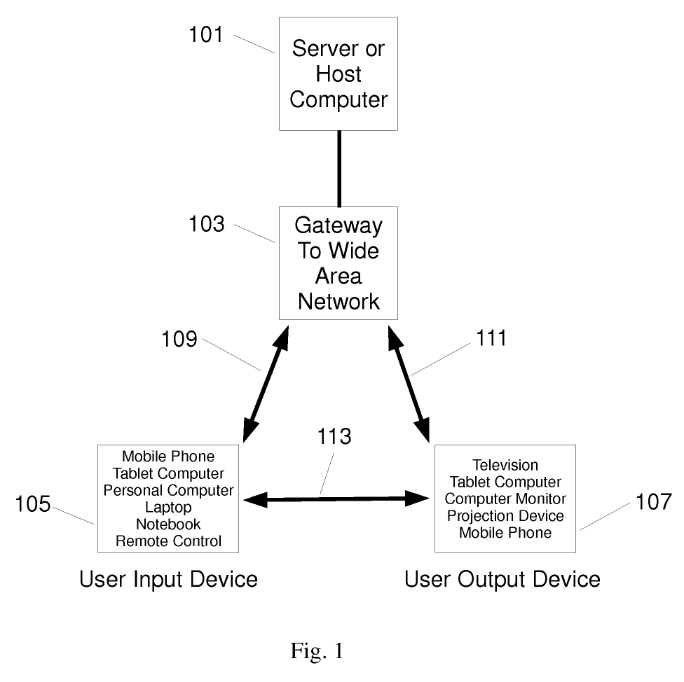

Referring now to the invention in more detail, a typical setup of the present invention is shown in FIG. 1. In FIG. 1 there is shown a typical communication setup for a single user. A server or host computer 101 connects to a wide area network gateway 103. The gateway 103 provides a primary bi-directional wired or wireless communication channel 109 to a user input device 105 such as tablet PC, or smart phone. The gateway 103 also provides a primary bi-directional wired or wireless communication channel 111 to a user output device 107. User input device 105 and user output device 107 are connected to each other over a secondary bi-directional communication channel 113 (e.g., bluetooth). A protocol is used to transmit data between gateway 103, the user input device 105, and the user output device 107 via the primary and secondary communications links 109, 111, and 113.

### Operation

The system of FIG. 1 may be operated in emergency messaging context, By way of example, the user causes the system to issue an emergency message on the user input device 105, e.g, by using special software application installed in the input device, voice activated commands, commands received by and recognized as such by the sensors of the input device (such as gyroscope, acceleration sensor, microphone, position sensor, etc), using dedicated buttons of the device, etc. The user input device 105 transmits the information about the emergency message (e.g., a text message, a voice message, a voice call, a video call, etc) to the gateway 103 via the primary communication channel 109. The gateway 103 transmits the information about the emergency message to the server 101. The user input device 105 transmits the same emergency message information to the user output device 107 via the secondary communication channel 113. The user output device 107 then also transmits the emergency call information to the gateway 103 and then to the server device 101 via the primary communication channel 111. The aforementioned procedure allows the gateway 103, the user input device 105, and the user output device 107 to share the same information about the emergency message. In addition, the user input device 105 may transmit the information about the emergency message directly to the output device 107 using the secondary communication channel 113. This allows the emergency message to be transmitted twice over two independent communications channels. These channels can be realized using cellular wide area networks and or Ethernet based wide area networks.

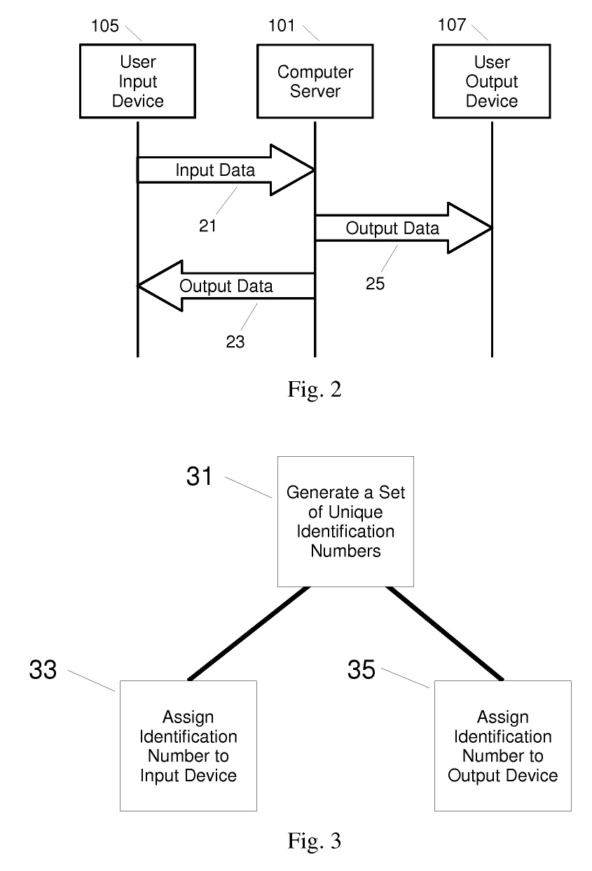

Referring now to FIG. 2 there is shown the computer server 101, the client input device 105 and the client output device 107 from FIG. 1. The computer server receives data such as emergency messages from the client input device 105 via an uplink channel 21. The computer server 101 may send data to the client input device 105 via a downlink channel 23. The computer server 101 may also send data to the client output device 107 via a downlink channel 25.

Referring now to the invention in more detail, in FIG. 3, process 301 run on a computer server 101 generates a unique identification number.. Process 35 downloads and stores the number on output device 107. Output device 107 displays the number to the user. Output device 107 prompts the user to enter the number on input device 105. When the user enters the correct number on input device 105, process 33 stores the same number on the input device 105. This process pairs a specific output device 107 with a specific input device 105. Subsequently, each message sent from the input device 107 to the server 101 via gateway 103 using uplink channel 21 carries the number as a signature. The server uses the signature to verify the origin and authenticity of the message. The server uses the verified signature to send display messages to the correctly paired output device 107 using downlink channel 25. The server also uses the verified signature to send display messages to the correctly paired input device 105 using downlink channel 23.

Accordingly, the reader will see that the communication system of this invention can be used to enable a robust communication protocol for a configuration with a server or host computer and at least two client devices.

Furthermore, the described communication system has the additional advantages in that

(a) it uses multiple communication protocols to increase the possibility of the successful transmission of a pairing or emergency message;

(b) it uses multiple communication channels to increase the possibility of the successful transmission of a pairing or emergency message;

(c) it passes information from the client devices to the server via independent local area networks;

(d) it uses the second client device and its network connection to retransmit the message sent by the first client device.

Further advantages are the usage of at least one wide area network on top of the local area networks to transmit the message.

Although the description above contains many specifications, these should not be construed as limiting the scope of the invention but as merely providing illustrations of some of the presently preferred implementations of this invention. For example, the input devices can be of different nature, such as touch-less sensors; the computer server can be split into several devices, etc.

Thus the scope of the invention should be determined by the appended claims and their legal equivalents, rather than by the examples given.

### REFERENCE NUMERALS IN DRAWINGS

101—Server or host computer

103—Gateway to wide area network

105—User input device

107—User output device

109—Communication link between gateway and user input device

111—Communication link between gateway and user output device

113—Communication link between user input device and user output device

21—Uplink between user input device and computer server

23—Downlink between computer server and user input device

25—Downlink between computer server and user output device

31—Generation of a set of unique identification numbers

33—Assignment of an identification number to an input device

35—Assignment of an identification number to an output device

1. A computer based emergency messaging system, comprising:
a server computer;
at least one user input device and at least one user output device connected to said server computer over a first communication link and connected to each other over a secondary communication link, thereby forming a pair of user devices, wherein said input device and said output device are located in close proximity so that the user can input and receive data using the input device while receive data using said output device, and wherein said user input device is adapted to receive user input and to send a message in response to said user input over said first communication link to said server computer, and
simultaneously to send said message over said second communication link to said output device, and said output device is adapted to forward said message over said first communication link to said server computer.

2. As in claim 1, wherein said message is an emergency message.

3. As in claim 2, wherein said user input device is selected from a group, consisting of a mobile phone, a smart phone, a tablet computer, a personal computer, a laptop computer, a netbook, a pocket PC, and a remote control device.

4. As in claim 3, wherein said user output device is selected from a group, consisting of a personal computer with a display device, an Internet connected TV set, a mobile phone.

5. As in claim 4, wherein said first communication link is a wireless communication link.

6. As in claim 5, wherein said second communication link is a wireless communication link.

7. A method of delivering emergency messages in a system, comprising a server computer, at least one user input device and at least one user output device connected to said server computer over a first communication link and connected to each other over a secondary communication link, the method comprising:
the user input device receiving a user input, the user input device forming a message, the user input device sending said message over said first communication link to the server computer, and over the second communication link to the output device, and said output device sending said message to said server computer over said first communication link.
